(19) United States
(12) Patent Application Publication
(10) Pub. No.: US 2024/0157584 A1
(43) Pub. Date: May 16, 2024

(54) MULTI-CHAMBER SMART SUCTION CUP FOR TACTILE SENSING

(71) Applicant: The Regents of the University of California, Oakland, CA (US)

(72) Inventors: Tae Myung Huh, Oakland, CA (US); Hannah S. Stuart, Oakland, CA (US); Monica Li, Oakland, CA (US)

(21) Appl. No.: 18/500,341

(22) Filed: Nov. 2, 2023

Related U.S. Application Data
(63) Continuation of application No. PCT/US2022/027381, filed on May 3, 2022.
(60) Provisional application No. 63/183,338, filed on May 3, 2021.

(51) Int. Cl. B25J 15/06; B25J 9/16; B25J 13/08

(52) U.S. Cl. CPC B25J 15/0683; B25J 9/1612; B25J 13/082; B25J 15/0625

(57) ABSTRACT

Multi-chamber suction cups, robotic gripper elements including the same and sensing methods are provided. A multi-chamber suction cup includes a single bellows suction cup structure, and at least one internal wall defining at least two internal chambers within the single bellows suction cup structure, each of the at least two internal chambers sharing a common port for connecting to a common vacuum source, and each of the at least two internal chambers including a port for connecting to separate pressure transducers. Using the novel suction cups, novel haptic exploration methods may be implemented that can estimate the surface texture of an object and the surface normal of a curved object using sliding and palpation motion, respectively. The suction cup can also be used to localize breaks in the suction seal when the suction cup is about to detach from an object.

### CROSS-REFERENCE TO RELATED APPLICATION

This patent application is a Continuation of International Patent Application PCTUS2022/027381, filed on May 3, 2022, which claims the benefit of U.S. Provisional Patent Application No. 63/183,338, filed May 3, 2021, both entitled, “MULTI-CHAMBER SMART SUCTION CUP FOR TACTILE SENSING.” Both of the afore-mentioned applications are incorporated by reference in their entireties for all purposes.

### BACKGROUND

Vacuum grippers are widely used to handle objects in industry. They perform astrictive grasping or, in other words, they apply attractive forces to object surfaces through suction pressure. The uni-contact suction cup has the advantage of simple operation and enables the handling of a wide range of items, including those that are delicate, large or inaccessible by a jaw gripper [1].

One major challenge in suction grasping is how to plan a contact location among a variety of object geometries. Examples of planning methods include the heuristic search of a surface normal [2] and neural network training of grasp affordance using binary success labels [3]. Wan et al. use CAD model meshes to plan a grasp resisting gravitational wrench [4], and Dex-Net 3.0 learns the best suction contact pose from a point cloud considering both suction seal formation and gravitational wrench resistance [5]. These methods rely on RGB or depth sensors, which may not perceive fine details critical to suction sealing success, e.g., texture, rugosity, porosity, etc. Vision may also become occluded in cluttered environments.

Another challenge arises during forceful manual manipulation. In industry, robotic speed is desired for time efficiency, however the inertial force induced by motion can cause grasping failure. Pham et al. use time-optimal path generation bounded by contact stability constraints to generate critically fast arm trajectories during pick-and-place [6]. Cheng et al. demonstrate an optimal control approach with a single suction gripper to reorient an object by extrinsic dexterity, utilizing external contacts from the table [7]. Both methods utilize known inertial properties of the gripped object. These types of dynamic and forceful maneuvers could be adaptively achieved with the addition of suction cup tactile sensing, especially for objects with properties that might compromise suction seal.

### SUMMARY

The present disclosure provides novel suction cups and sensing methods. According to embodiments, a suction cup includes inner chambers, each of which connects to a pressure transducer to estimate distributed flow rates. From the distributed leakage airflow rate measures, surface properties of engaging objects and impending local suction seal breaks during a forceful robotic manipulation may be estimated or determined. For example, sensing can be incorporated into the suction mechanism to monitor local contact geometry, e.g., through haptic exploration.

The various embodiments provide a suction cup robotic gripper element configured to measure local contact state through suction flow monitoring. In an embodiment, a single-bellows suction cup includes internal wall structures separating the suction cup into multiple, e.g., four, internal chambers. Each chamber connects with its own remote pressure transducer, which enables both absolute and differential pressure measures between chambers. The distribution of pressure represents the contact states whether the vacuum seal is evenly formed or any leakage airflow exists. Using this smart suction cup, a novel haptic exploration method may be implemented that can estimate the surface texture of an object and the surface normal of a curved object by using sliding and palpation motion, respectively. The suction cup can also be used to localize breaks in the suction seal when the suction cup is about to detach from an object.

In an embodiment, a multi-chamber suction cup is provided that includes a single bellows suction cup structure; and at least one internal wall defining at least two internal chambers within the single bellows suction cup structure, each of the at least two internal chambers sharing a common port for connecting to a common vacuum source, and each of the at least two internal chambers including a port for connecting to separate pressure transducers (e.g., a dedicated pressure transducer for each chamber).

According to certain aspects, the multi-chamber suction cup includes at least two internal walls defining four internal chambers. According to certain aspects, the single bellows suction cup structure includes a symmetrical, deformable body structure including an external opening located along a central axis of the body structure, and a deformable lip surrounding the external opening and distal from the central axis. According to certain aspects, the at least one internal wall divides the external opening into at least two opening portions, each of the at least two opening portions coupled to a corresponding one of the at least two internal chambers.

According to an embodiment, a robotic arm fixture coupling to the multi-chamber suction cup is provided. According to certain aspects, the robotic arm fixture includes a common vacuum source connected to the common port, a separate pressure transducer coupled to each internal chamber, and a controller including a processor, the controller configured to receive signals representative of a pressure within a chamber from each of the separate pressure transducers. According to certain aspects, the controller is configured to control operation of the vacuum source so as to regulate the vacuum pressure applied to the internal chambers through the common port. According to certain aspects, the controller is configured to modulate the vacuum pressure with pulse width modulation at a frequency of between about 1 Hz and about 1000 Hz.

According to an embodiment, a method of measuring contact information of a surface of an object is provided. The method includes applying a vacuum pressure to an orifice of a multi-chamber suction cup and measuring a signal using a pressure transducer coupled with a bellows within the suction cup as the orifice of the suction cup is resting on the surface or actively positioned on the surface or moved along the surface or actively removed from the surface, the bellows being coupled with the orifice.

According to an embodiment, a method of measuring contact information of a surface of an object is provided. The method includes applying a vacuum pressure to an orifice of a suction cup as the orifice of the suction cup is resting on or positioned on the surface or moved along the surface, and measuring a signal representing a pressure within the bellows using at least one pressure transducer coupled with a bellows within the suction cup as the orifice of the suction cup is resting on or positioned on the surface or moved along the surface, the bellows being coupled with the orifice.

According to certain aspects, the suction cup includes a multi-chamber suction cup, comprising a single bellows suction cup structure, and at least one internal wall defining at least two internal chambers within the single bellows suction cup structure, each of the at least two internal chambers sharing a common port for connecting to a common vacuum source, and each of the at least two internal chambers including a port for connecting to separate pressure transducers. Each pressure transducer is configured to measure a signal representing a pressure within its respective internal chamber. According to certain aspects, the applying a vacuum pressure includes modulating the vacuum pressure at a frequency ranging from about 1 Hz to about 1000 Hz.

According to an embodiment, a robotic arm fixture is provided that includes a support structure, a vacuum port on or within the support structure and configured to connect to a vacuum source, a multi-chamber suction cup coupled with the support structure, the multi-chamber suction cup including a single bellows suction cup structure and at least one internal wall defining at least two internal chambers within the single bellows suction cup structure, each of the at least two internal chambers sharing the vacuum port, and at least two pressure transducers, each fluidly coupled to a respective one of the at least two internal chambers of the multi-chamber suction cup.

According to certain aspects, the multi-chamber suction cup includes at least two internal walls defining four internal chambers within the single bellows suction cup structure.

According to certain aspects, the single bellows suction cup structure includes a symmetrical, deformable body structure including an external opening located along a central axis of the body structure, and a deformable lip surrounding the external opening.

According to certain aspects, the robotic arm fixture further includes a controller including a processor and a memory, the controller configured to receive signals representative of a pressure within a corresponding internal chamber from each of the at least two pressure transducers. According to certain aspects, the controller is configured to control the vacuum source to apply a vacuum pressure and to modulate the vacuum pressure with pulse width modulation at a frequency of between about 1 Hz and about 1000 Hz.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF DRAWINGS

FIG. 1 illustrates a fixture including a multi-chamber smart suction cup gripping a water bottle; as shown, the cup has four internal chambers, each connected to a separate pressure transducer that provides a measure of internal flow rate.

FIG. 2 shows an isometric view of a fixture holding a multi-chamber suction cup, according to an embodiment.

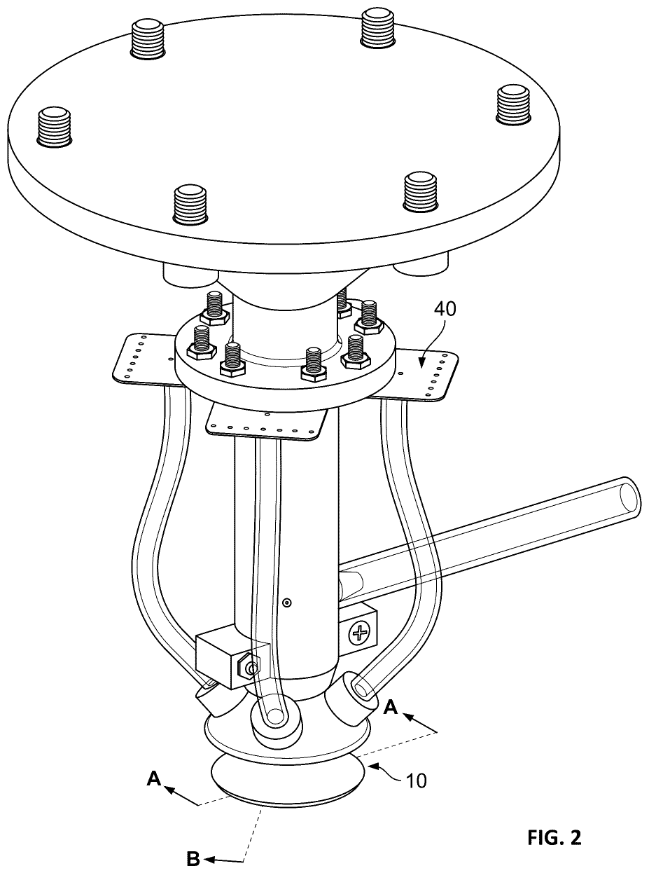

FIG. 3 shows a sectional view (along section B-B in FIG. 2) of the fixture holding the multi-chamber suction cup shown in FIG. 2.

FIG. 4 shows a sectional view (along section A-A in FIG. 2) of the fixture holding the multi-chamber suction cup shown in FIG. 2.

FIGS. 5A-5C illustrates a casting mold and design of a suction cup according to an embodiment: FIG. 5A illustrates a casting mold with three parts (2 Outer shells and 1 core), with the molds aligned and fixed by pins and bottom bolts; FIG. 5B illustrates a resulting suction cup connected with vacuum connector and hoses to the pressure sensors; and FIG. 5C illustrates a cross-sectional view of the suction cup, showing internal and outer key dimensions.

FIGS. 6A-6B shows two cases of CFD simulation (dark blocks are engaged objects): FIG. 6A shows vertical leakage airflow, and FIG. 6B shows horizontal leakage airflow.

FIGS. 7A-7B shows CFD result of the Pvac measured at the sensor locations of each chamber, with bar graphs scaled to represent the 0.4 kPa from the maximum of the four Pvacs: FIG. 7A shows a vertical orifice and FIG. 7B shows a horizontal orifice.

FIGS. 8A-8B illustrate cross sectional views of the pressure distribution (arrows inside represents relative logarithmic scale of air flow velocity; the colormap unit is kPa): FIG. 8A shows the view for the vertical orifice and FIG. 8B shows the view for the horizontal orifice.

FIG. 9 illustrates the magnitude of discrete Fourier transform (DFT) of the lower vacuum mode at 30 Hz.

FIG. 10 illustrates sliding test results on a wavy-smooth acrylic pair: (top) snapshot of the sliding motion at the time marked with dashed line; (middle) average short time Fourier transform at PWM frequency (|STFT₃₀|) of all four channels; (bottom) difference of |STFT₃₀|) between right two channels and left two channels (shading shows when a large transition (no seal to seal) occurs).

FIG. 11 illustrates test results of seeking surface normal: (left) experiment setup for seeking a surface normal on a curved object (for all approach angles (θ), the suction cup pressing force is 1N); (right) each data-point represents the mean of three trials (the Fourier transform at 30 Hz (|DFT₃₀|) shows symmetric trends about the surface normal (0 deg)).

FIG. 12 illustrates vacuum pressure measured at each chamber during a detaching motion (insets are gray-scaled image frames from the FTIR sensor).

### DETAILED DESCRIPTION

The following detailed description is exemplary in nature and is not intended to limit the invention or the application and uses of the invention. Furthermore, there is no intention to be bound by any expressed or implied theory presented in the following detailed description or the appended drawings.

According to various embodiments, novel multi-chamber suction cups and novel sensing methods using the suction cups are provided. In certain embodiments, the multi-chamber suction cups are coupled with a fixture adapted for robotic manipulation applications.

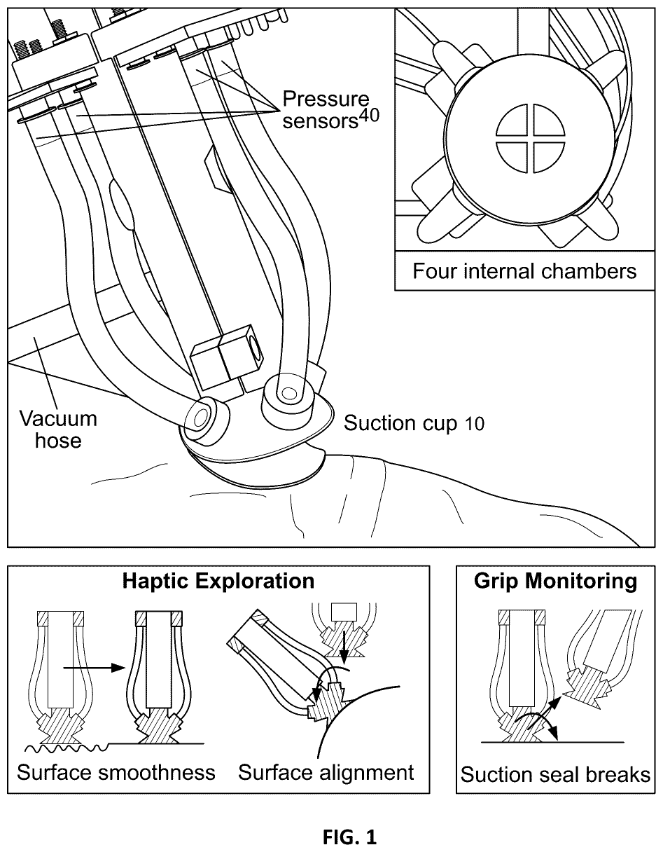

FIG. 1 illustrates a fixture including a multi-chamber smart suction cup 10 gripping a water bottle, according to an embodiment; as shown in FIG. 1 (top), the cup 10 has four internal chambers, each including a port connected to a separate pressure transducer 40 that provides a measure of internal flow rate. Other means to monitor the flow rate may include a mechanical flow meter (e.g., paddle wheel), an optical-based sensor, a thermal mass flow meter or other pressure-based meters structures, such as a venturi meter or other structures as are well known.

The suction cup enables localizing small breaks in the seal due to, for example, the rugosity (e.g., wrinkles, bumps, etc.) of the object surface or the application of external wrenches or torques. In certain embodiments, overall vacuum pressure may be modulated to achieve different exploratory haptic procedures, such as sliding across surfaces. From the distributed leakage air flow rate measures, the suction cup enables estimating the surface properties of engaging objects and impending local suction seal breaks during a forceful robotic manipulation.

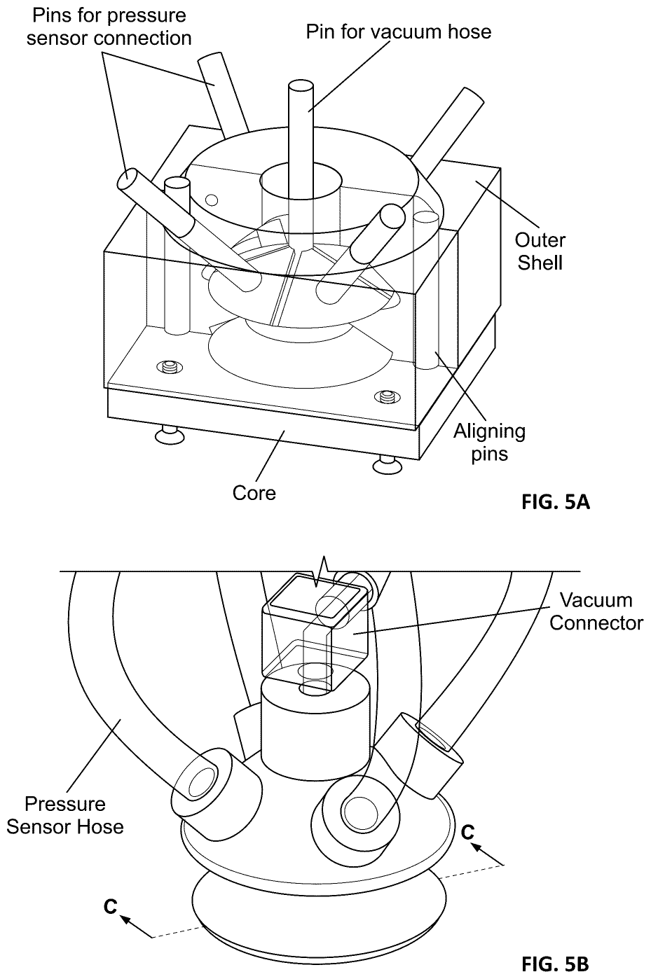

The multi-chamber suction cup 10 utilizes airflows inside the chambers to monitor local contacts. In an embodiment, internal wall structures separate the suction cup bellows into four chambers as shown in FIG. 1 (top). In an embodiment, the suction cup 10 includes at least one internal wall within the bellows defined by the suction cup structure. For example, the structure may define a single bellows, with the at least one wall defining at least two internal chambers within the bellows suction cup structure, effectively creating at least two bellows, but with each of the at least two internal chambers sharing a common port 30 (see, e.g., FIG. 5C) for connecting to a common vacuum source, and each of the at least two internal chambers including a port for connecting to a separate pressure transducer 40, e.g., via a hose, tube or line. As shown in the embodiment of FIG. 1 (top), the suction cup includes four chambers defined by at least two internal walls (e.g., arranged in a cross-pattern centered on a center axis of the suction cup), or alternately four walls meeting along the suction cup axis.

In another embodiment, the suction cup structure may include or define two or more bellows, with at least one wall within each bellows defining at least two internal chambers within each bellows. In yet another embodiment, the suction cup structure may include or define two or more bellows, with at least one of the two or more bellows not including an internal wall structure as described herein.

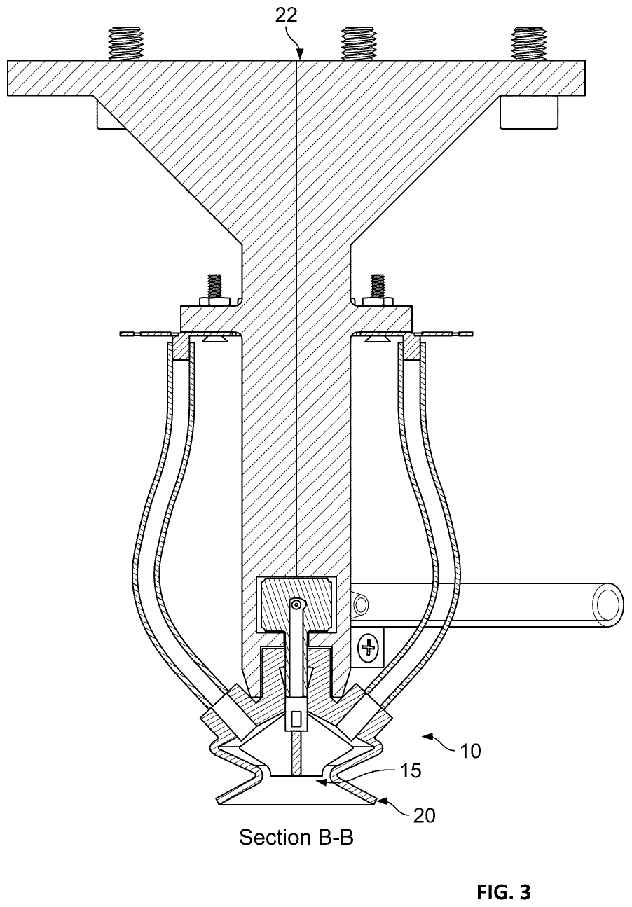

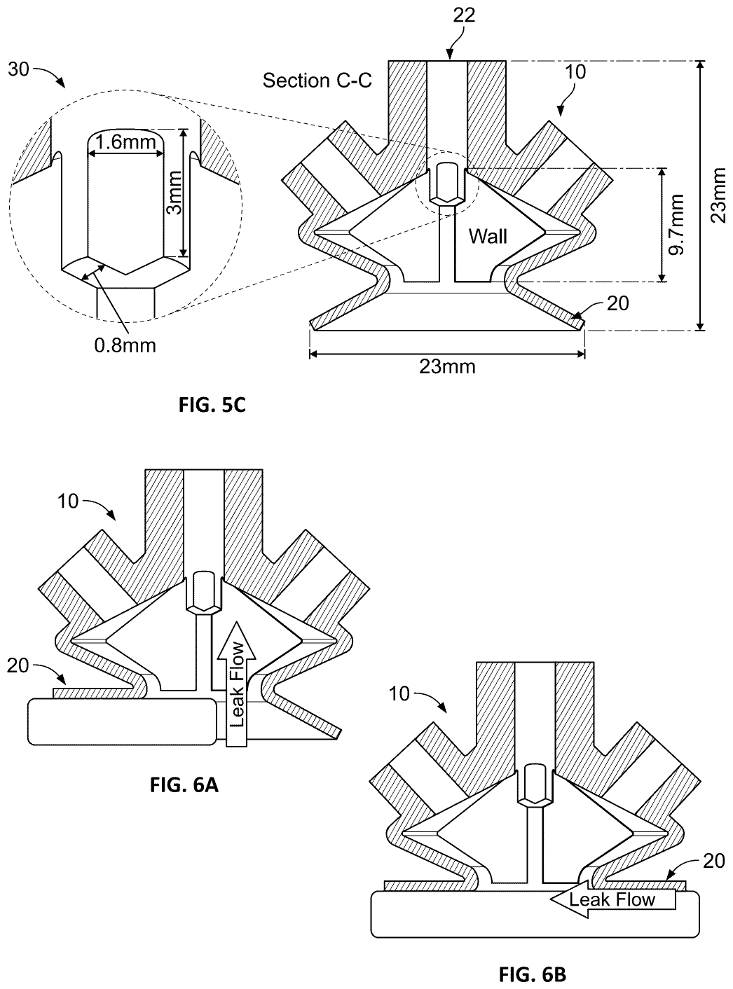

In an embodiment, the structure of suction cup 10 includes a symmetrical, deformable body structure including an external opening or orifice 15 located along a central axis 22 of the body structure. The opening or orifice 15 defines the opening to the two or more chambers. In an embodiment, the structure also include a deformable lip 20 surrounding the external opening 15 and distal from the central axis 22. As shown in FIG. 3 and FIG. 5C for example, the lip 20 may flare outwardly relative to the external opening or orifice 15. FIG. 6A and FIG. 6B show examples of lip 20 deforming when in contact with a surface.

The at least one internal wall divides the external opening 15 into at least two opening portions, each of the at least two opening portions coupled to a corresponding one of the at least two internal chambers. Again, in the FIG. 1 (top) example, four equal size internal chambers are shown. In the disclosed embodiments, the chambers are preferably the same size/volume, but they need not be the same size/volume.

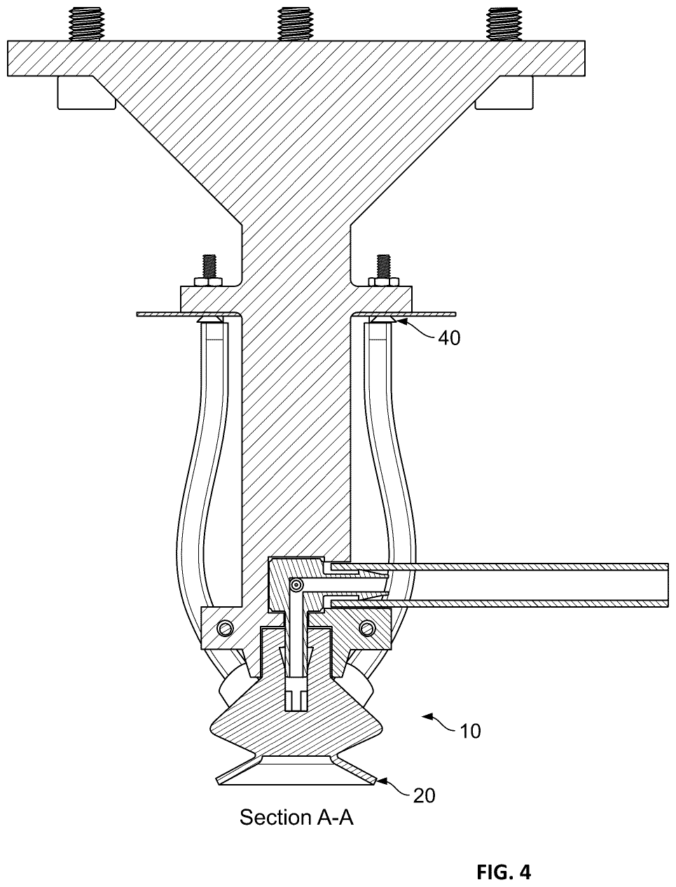

Suction airflow is provided by a vacuum source coupled with a port 30 common to all chambers. A vacuum hose or line may couple the vacuum source to the common port 30. In an embodiment, the vacuum hose or line connects to the common port along the central axis 22 as shown in FIG. 3 and FIG. 4. The suction airflow is separated into each internal chamber and the pressure sensor 40 connected to each chamber provides an estimated local flow rate.

In an embodiment, the wall structure is implemented inside a single-bellows suction cup, as shown in FIG. 5C due to its versatility on different curvatures and orientations of objects. In an embodiment, the internal wall structure only spans the proximal portion of the suction cup, in order to maintain typical flexibility, deformation and seal formation in the distal lip 20 of the suction cup.

In an embodiment, fabrication of a suction cup, including the chamber walls, may be performed in a single-step casting of silicone rubber or other material as is well known for suction cups. As an example, the casting mold may be comprised of three parts, two outer shells and one core as shown in FIG. 5A, that are 3D printed using a fine resolution printer, e.g., SLA type (e.g., Formlabs, Form2). To ensure the clean casting of the thin wall structures (e.g., 0.8 mm thick), a syringe with a blunt needle (e.g., gauge 14) may be used to inject uncured RTV silicone rubber (e.g., Smooth-On, MoldMax 40) and vacuum-degassed the injected material. After curing, e.g., for 24 hours at room temperature, the outer shells are removed and the suction cup is stretched and peeled off of the inner core mold. Tearing of the silicone can occur during this step, especially with harder rubbers. When a harder rubber material is desired for the suction cup, the core mold should be designed for a draft angle that the material can stretch with.

CFD Simulation

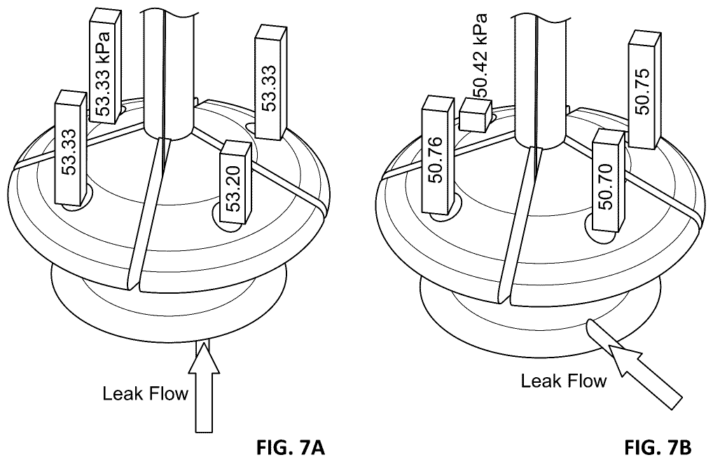

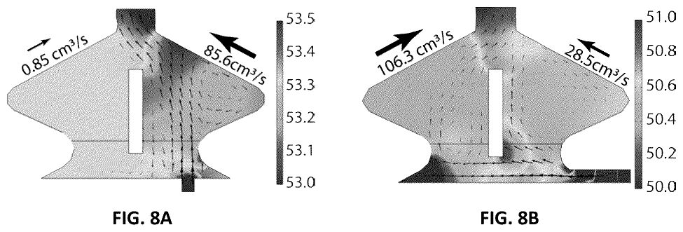

Using Computational Fluid Dynamics (CFD) simulation (e.g., COMSOL Multiphysics, k-E turbulence model), an evaluation was made of an embodiment of a suction cup gripper in two suction flow cases: vertical and horizontal flow, as shown in FIGS. 6A-6B. The vertical flow case emulates when the suction cup only partially contacts a surface, or when the surface's shape inhibits sealing. However, when the suction cup engages with a smooth flat surface, flow can only move inward from the outer edges of the cup, as in the horizontal flow case. This horizontal leak is common when the suction cup is wrenched from the surface after a suction seal is formed. Although the suction cup will deform under vacuum pressure, modeled rigid geometry was used in the CFD simulation. For each case, the leak flow direction was approximated with a small pipe (D=1 mm, L=7 mm) located close to one of the internal chambers as shown in FIGS. 7A-7B and FIGS. 8A-8B. The boundary conditions of the vacuum pump pressures and flow rates match the experimental vacuum generator used.

The simulation results suggest that the suction cup gripper can locate leakage flow using differences between the four pressure transducers. Vacuum pressure (P_{vac}) may be defined as the difference between atmosphere air pressure (Pₐₜₘ) and the chamber pressure (P_{chamber}), or

P_{vac}=Pₐₜₘ−P_{chamber} (1)

In the vertical leakage flow case, P_{vac} close to the leaking orifice shows the least vacuum pressure than the others as shown in FIG. 7A. On the other hand, the horizontal leakage causes the diagonally opposite channel to have the lowest P_{vac} as shown in FIG. 7B. These trends are supported by the flow results shown in FIGS. 8A-8B, where the vertical and horizontal orifices produce the highest flow rate in opposite chambers. Using these chamber pressure distributions for different contact cases, the sensor can detect an imperfect suction cup alignment with an object and localize the suction seal breaks.

In certain embodiments, measurements of the pressures inside the suction cup (e.g., inside each chamber) are used for estimating vacuum seal quality, contact surface characteristics, and location of suction seal breaks. As demonstrated in [8], pressure sensors attached to a suction cup can be used to regulate the vacuum pressure if the necessary vacuum level is not achieved. In embodiments herein, the overall vacuum level inside the suction cup can be used to estimate the texture or porosity of the engaging surface and the maximum lifting weight can be estimated from it. When approaching an unknown object, the distribution of pressure in the suction cup may be used to check if the suction cup made even contact over the surface or partial contact due to misalignment. The distribution of the pressure informs the location of the leakage air flows, which may be used by a controller (e.g., feedback mechanism) to adapt to move the contact point accordingly. When manipulating an object using full vacuum power, the sensor can advantageously predict the onset of leakage flow and locate the vacuum seal breakpoint, enabling any adaptive robotic control to prevent impending grasping failure. These capabilities are particularly useful for an e-commerce warehouse where a robotic suction cup needs to handle unknown objects with various shapes and weights.

Prior tactile sensors designed for use in suction cups provide partial information about object properties and vacuum sealing state. Aoyagi et al. coat a piezoresistive polymer on a bellows suction cup to measure compression forces [9]. Doi et al. implement a capacitive proximity sensor on the base plate of a suction cup end-effector to measure the distance from the plate to the object surface [10]. These methods measure vacuum state indirectly from the deformation of the suction cup and proximity to the object. Another straight-forward approach is to monitor internal vacuum pressure of the suction cup as a discrete measure of suction sealing, as in [11]. None of these methods localize the source of a leak or measure local surface geometry as do the smart suction cups in the present embodiments. Muller et. al. developed a circular array of 16 piezoresistive force sensors that are attached to the lip of the bellows suction cup [12]. This sensor array can measure the distribution of local normal forces when grabbing a curved object, and the sensor data can estimate the curvature. Compared with this sensor, the present embodiments do not add any structures on the contact lip, and thereby do not affect the vacuum seal formation. Moreover, the present embodiments use air pressure transducers located remotely, while the prior work requires sensor connection at the suction cup lip, making the system cumbersome.

In an embodiment with four internal chambers, the spatial resolution of the suction cup can only differentiate four directions. If higher resolution is desired, other embodiments of the suction cup can include more chambers and pressure transducers, and/or a sophisticated software algorithm, such as the artificial neural network, to achieve the spatial resolution. Accordingly, various suction cup embodiments may include a bellows structure with an internal wall or walls defining two internal chambers, three internal chambers, four internal chambers, or any number of internal chambers.

Exemplary Use

A multi-chamber suction cup according to an embodiment herein may be mounted on a robotic arm via a structure/fixture, e.g., a 3D printed fixture as shown in FIG. 1. The fixture can also host pressure sensing transducers remotely from the suction cup, allowing the suction cup to remain small and flexible. Four ported pressure transducers (e.g., Honeywell, MPRLS 0025PA) connect with the four chambers of the suction cup via polyurethane tubes. More compliant tubes, e.g., silicone tubes, can be used if a more flexible connection is required. The fixture can also host vacuum connectors as shown in FIG. 5B. The fixture can be made in two parts, clamping the suction cup and holding it during manipulation.

In an embodiment, the pressure in each chamber of a multi-chamber suction cup can be measured using separate pressure transducers, e.g., MEMS pressure transducers that have built-in Analog to Digital Converter (ADC), such as Honeywell, MPRLS 0025PA (maxi-mum sampling rate 200 Hz) dedicated to each chamber. If a faster sampling rate is desired, analog pressure transducers (e.g., NXP MPXV4115V) can be used with external ADC that samples faster.

A multi-chamber suction cup can be used to explore the surface textures and geometries of an object. For example, to seek the best suction contact location, the vacuum pressure can be lowered for gentle haptic exploration, e.g., sliding and palpating. To achieve lower vacuum pressure, a solenoid valve can regulate the pressure. For example, a vacuum generator (e.g., VacMotion, VM5-NA) converts compressed air to a vacuum source. A solenoid valve (e.g., SMC pneumatics, VQ110, On/off time=3.5/2 ms), commanded by a microcontroller, regulates the compressed air as a means of moderating vacuum intensity. During haptic exploration, the valve may be controlled with pulse width modulation (PWM) at a frequency of 30 Hz with 30% duty cycle to approximate lower vacuum pressures. Different frequencies and duty cycles can be chosen considering the on/off time of a solenoid valve, e.g., a frequency ranging from about 1 Hz to about 1000 Hz may be used.

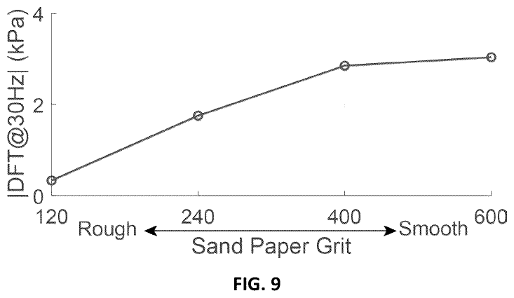

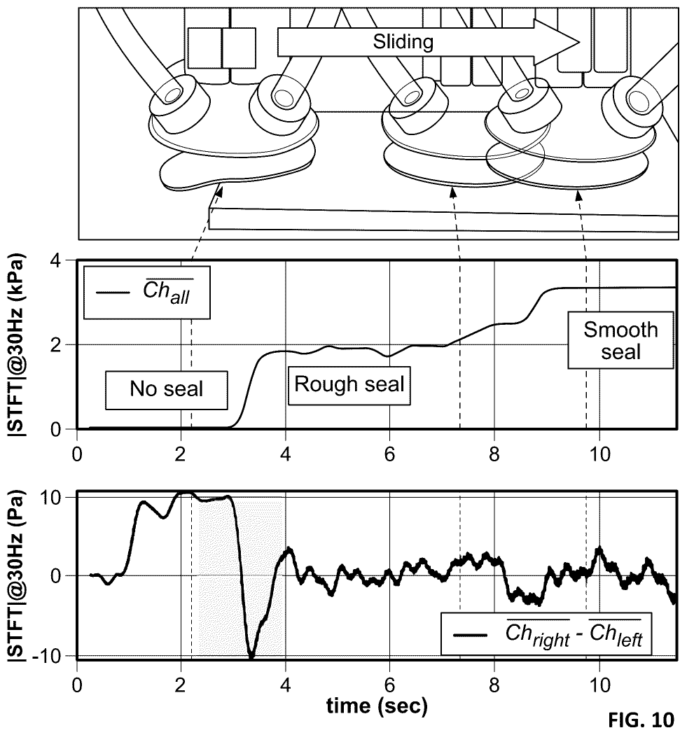

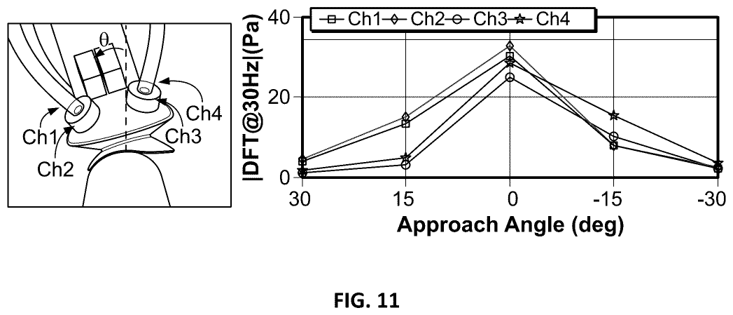

The measured pressure from each chamber also oscillates at the PWM frequency, and the frequency response analysis, i.e., Fourier transform, at that frequency represents the surface textures and curvatures. As shown in FIG. 9, the magnitude of the Fourier transform can differentiate the surface roughness. Using sliding motion enabled by lower vacuum forces, the multi-chamber suction cup can be used to monitor gradual changes of surface properties as shown in FIG. 10. The difference of Fourier transform in the leading-edge chamber (C̅h̅_̅{̅r̅i̅g̅h̅t̅}̅) and following-edge chamber (C̅h̅_̅{̅l̅e̅f̅t̅}̅) can locate the initial half contact and monitor a transition from no seal to seal. The average Fourier transform over all chambers (C̅h̅ₐ̅ₗ̅ₗ̅) estimates the surface textures, which provide a desirable vacuum engage location. Using palpation on a curved object, the multi-chamber suction cup can be used to seek the surface normal around the tip as shown in FIG. 11. The Fourier transform of each chamber pressure shows symmetric trends about the surface normal (0 deg) and the magnitudes are maximum at surface normal, meaning that the surface normal is the best vacuum contact point on this object.

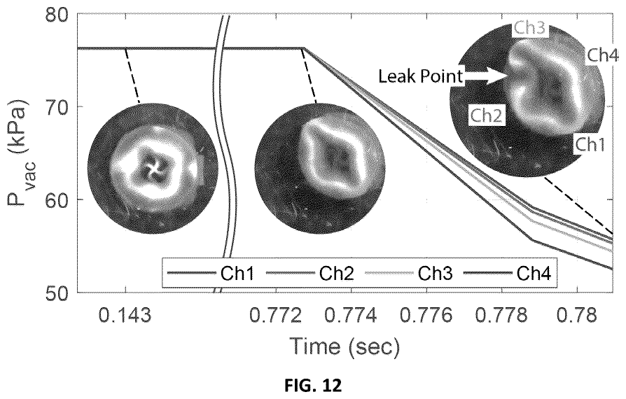

Another utility of a multi-chamber suction cup is to monitor detaching contact during manipulation of full vacuum mode. An example detaching sequence from a flat surface is shown in FIG. 12. As the suction cup deforms under the detaching motions, the vacuum seal (bright ring) also deforms and then leaks. The vacuum pressure (P_{vac}) in each chamber does not vary while the vacuum seal remains, but lowers at the onset of the leak. The difference in P_{vac} among chambers shows expected trends based on the horizontal leakage CFD simulation in FIG. 7B. The example in FIG. 12 shows the least P_{vac} in the chamber opposite to the leak point; the leak occurs near ‘Ch2’ and the pressure drops most rapidly for ‘Ch4’. To predict local vacuum seal states in this highly deformable suction cup, a trained artificial neural network (e.g., LSTM) can be used. The information of this leakage point can be used for adaptive robotic control that prevents catastrophic suction grasping failure.

Some embodiments further include a non-transitory computer-readable storage medium (e.g., volatile and/or non-volatile memory devices) storing instructions that, when executed by a processor or processors, perform one or more of the methods of data analysis and/or feedback and control functionality as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the embodiments (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosed embodiments and does not pose a limitation on the scope of the disclosure unless otherwise claimed. No language in the specification should be construed as indicating any non-claimed element as essential to the practice of the embodiments.

Exemplary embodiments are described herein. Variations of those exemplary embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, the scope of the disclosure includes all modifications and equivalents of the subject matter recited herein and in the claims appended hereto as permitted by applicable law. Moreover, any combination of the above-described elements in all possible variations thereof is encompassed by the disclosure unless otherwise indicated herein or otherwise clearly contradicted by context.

### REFERENCES

[1] N. Correll, K. E. Bekris, D. Berenson, O. Brock, A. Causo, K. Hauser, K. Okada, A. Rodriguez, J. M. Romano, and P. R. Wurman, “Analysis and observations from the first amazon picking challenge,” IEEE Trans. Automation Science and Engineering, vol. 15, no. 1, pp. 172-188, 2016.
[2] D. Morrison, A. W. Tow, M. Mctaggart, R. Smith, N. Kelly-Boxall, S. Wade-Mccue, J. Erskine, R. Grinover, A. Gurman, T. Hunn et al., “Cartman: The low-cost cartesian manipulator that won the amazon robotics challenge,” in ICRA. IEEE, 2018, pp. 7757-7764.
[3] A. Zeng, S. Song, K.-T. Yu, E. Donlon, F. R. Hogan, M. Bauza, D. Ma, O. Taylor, M. Liu, E. Romo et al., “Robotic pick-and-place of novel objects in clutter with multi-affordance grasping and cross-domain image matching,” in ICRA. IEEE, 2018, pp. 3750-3757.
[4] W. Wan, K. Harada, and F. Kanehiro, “Planning grasps with suction cups and parallel grippers using superimposed segmentation of object meshes,” IEEE Transactions on Robotics, 2020.
[5] J. Mahler, M. Matl, X. Liu, A. Li, D. Gealy, and K. Goldberg, “Dex-net 3.0: Computing robust vacuum suction grasp targets in point clouds using a new analytic model and deep learning,” in ICRA. IEEE, 2018, pp. 5620-5627.
[6] H. Pham and Q. C. Pham, “Critically fast pick-and-place with suction cups,” ICRA, vol. 2019-May, pp. 3045-3051, 2019.
[7] X. Cheng and M. T. Mason, “Manipulation with suction cups using external contacts,” in ISRR, 2019.
[8] M. J. Golden, “Vacuum cup control apparatus,” Feb. 23, 1993, U.S. Pat. No. 5,188,411.
[9] S. Aoyagi, M. Suzuki, T. Morita, T. Takahashi, and H. Takise, “Bellows suction cup equipped with force sensing ability by direct coating thin-film resistor for vacuum type robotic hand,” IEEE/ASME Transactions on Mechatronics, vol. 25, no. 5, pp. 2501-2512, 2020.
[10] S. Doi, H. Koga, T. Seki, and Y. Okuno, “Novel proximity sensor for realizing tactile sense in suction cups” in ICRA. IEEE, 2020, pp. 638-643.
[11] C. Eppner, S. Höfer, R. Jonschkowski, R. Martin-Martín, A. Sieverling, V. Wall, and O. Brock, “Lessons from the amazon picking challenge: Four aspects of building robotic systems.” in Robotics: science and systems, 2016.

1. A multi-chamber suction cup, comprising:
a single bellows suction cup structure; and
at least one internal wall defining at least two internal chambers within the single bellows suction cup structure, each of the at least two internal chambers sharing a common port for connecting to a common vacuum source, and each of the at least two internal chambers including a port for connecting to separate pressure transducers.

2. The multi-chamber suction cup of claim 1, including at least two internal walls defining four internal chambers.

3. The multi-chamber suction cup of claim 1, wherein the single bellows suction cup structure includes a symmetrical, deformable body structure including an external opening located along a central axis of the body structure, and a deformable lip surrounding the external opening.

4. The multi-chamber suction cup of claim 3, wherein deformable lip surrounding the external opening flares away from the central axis

5. The multi-chamber suction cup of claim 3, wherein the at least one internal wall divides the external opening into at least two opening portions, each of the at least two opening portions coupled to a corresponding one of the at least two internal chambers.

6. A robotic arm fixture including a support structure coupling to the multi-chamber suction cup of claim 1.

7. The robotic arm fixture of claim 6, including a common vacuum source connected to the common port, a separate pressure transducer coupled to each internal chamber, and a controller including a processor, the controller configured to receive signals representative of a pressure within a corresponding internal chamber from each of the separate pressure transducers.

8. The robotic arm fixture of claim 7, wherein the controller is configured to control operation of the common vacuum source so as to regulate the vacuum pressure applied to the internal chambers through the common port.

9. The robotic arm fixture of claim 8, wherein the controller is configured to modulate the vacuum pressure with pulse width modulation at a frequency of between about 1 Hz and about 1000 Hz.

10. A method of measuring contact information of a surface of an object, the method comprising:
applying a vacuum pressure to an orifice of a suction cup as the orifice of the suction cup is resting on or positioned on the surface or moved along the surface; and
measuring a signal using at least one pressure transducer coupled with a bellows within the suction cup as the orifice of the suction cup is resting on or positioned on the surface or moved along the surface, the bellows being coupled with the orifice.

11. The method of claim 10, wherein the suction cup includes a multi-chamber suction cup, comprising:
a single bellows suction cup structure; and
at least one internal wall defining at least two internal chambers within the single bellows suction cup structure, each of the at least two internal chambers sharing a common port for connecting to a common vacuum source, and each of the at least two internal chambers including a port for connecting to separate pressure transducers.

12. The method of claim 10, wherein the applying a vacuum pressure includes modulating the vacuum pressure at a frequency ranging from about 1 Hz to about 1000 Hz.

13. A robotic arm fixture, comprising
a support structure;
a vacuum port on or within the support structure and configured to connect to a vacuum source;
a multi-chamber suction cup coupled with the support structure, the multi-chamber suction cup including a single bellows suction cup structure and at least one internal wall defining at least two internal chambers within the single bellows suction cup structure, each of the at least two internal chambers sharing the vacuum port; and
at least two pressure transducers, each fluidly coupled to a respective one of the at least two internal chambers of the multi-chamber suction cup.

14. The robotic arm fixture of claim 13, wherein the multi-chamber suction cup includes at least two internal walls defining four internal chambers within the single bellows suction cup structure.

15. The multi-chamber suction cup of claim 13, wherein the single bellows suction cup structure includes a symmetrical, deformable body structure including an external opening located along a central axis of the body structure, and a deformable lip surrounding the external opening.

16. The robotic arm fixture of claim 13, further including a controller including a processor and a memory, the controller configured to receive signals representative of a pressure within a corresponding internal chamber from each of the at least two pressure transducers.

17. The robotic arm fixture of claim 16, wherein the controller is configured to control the vacuum source to apply a vacuum pressure and to modulate the vacuum pressure with pulse width modulation at a frequency of between about 1 Hz and about 1000 Hz.
